(19) United States
(12) Patent Application Publication
(10) Pub. No.: US 2011/0176427 A1
(43) Pub. Date: Jul. 21, 2011

(54) Monitoring Performance of Telecommunications Network

(76) Inventors: Yangcheng Huang, Athlone (IE); Sidath Handurukande, Athlone (IE)

(21) Appl. No.: 12/997,589

(22) PCT Filed: Jun. 25, 2008
(86) PCT No.: PCT/EP08/58066

§ 371 Date: Mar. 23, 2011

(51) Int. Cl. H04L 12/26

(52) U.S. Cl. 370/241

(57) ABSTRACT

A method of monitoring performance of a telecommunications network transmitting in real time multimedia data from a content provider to a device operating in the network is disclosed. The method comprises the steps of receiving said multimedia data; collecting information about the connection used to receive the multimedia data; producing a receiver report; appending said report with an identifier of a segment of the telecommunications network in which the device operates and transmitting said report to said telecommunications network.

### TECHNICAL FIELD

The present invention relates to telecommunications networks, in general, and in particular to monitoring reception of multimedia data transmitted in real time in a telecommunications network.

### BACKGROUND

IPTV multimedia services (e.g., Mobile TV, i.e. television channels received using mobile phones via 3G telecommunications network, and IP TV, i.e. television channels received via fixed IP networks) are growing in popularity amongst users. In order to attract and maintain subscribers paying for the service the quality of transmission of video and audio has to be on a high and constant level. In order to deliver multimedia data to individual subscribers in the solutions known in the art telecommunications networks use RTSP/RTP/RTCP suite of protocols.

RTCP (Real-time Transport Control Protocol) is an important control protocol which is a component of the Real-time Transport Protocol (RTP). It partners RTP in the delivery and packaging of multimedia data. RTCP periodically transmits control packets to participants in a streaming multimedia session, enabling group size estimation and the distribution and calculation of session-specific information such as packet loss and round trip time to other hosts. RTCP is defined in RFC 3550.

RTCP and RTP are used in Packet Core of converged TV solution. The Protocol Core provides the basic functionality for the communication between a client and a server. It waits for clients to connect, receives the client's requests and processes them. After that it connects to the server(s), and forwards the client requests to the server(s). Likewise, it receives the server's responses, processes them, and sends them back to the clients. Especially, the Protocol Core uses RTSP/RTP/RTCP to communicate with user terminals (e.g., mobile terminal) or with other designated network nodes and with Streaming Server, while streaming 3GPP compliant media content. RTSP stands for Real Time Streaming Protocol. RTSP allows a client to remotely control a streaming media server by issuing commands such as play and pause. It also allows time-based access to files on a media server.

The disadvantage of using RTP/RTCP in delivering multimedia content to a subscriber unit also known as User Equipment (UE) is that the standard RTCP only provides basic and very limited information about the source of the RTCP Receiver Reports (RR). It only provides IP address to identify a report sender (i.e. user terminals). IP address, however, is not sufficient for fault diagnosis (especially for root cause analysis) in certain cases, because in large networks different receivers of media will experience different quality of service due to location specific reasons. Packet drops or jitter might be caused by local reason, such as terminal mobility and other factors that might lead to signal fading. Therefore the information provided is related to a single user. Instead, network administrators are interested in user experiences of a network or a group of users. Additionally the IP address acts as a locator for one IP device to find another and interact with it. It is not intended, however, to act as an identifier that always uniquely identifies a particular device. In current practice, an IP address is not always a unique identifier, due to technologies such as dynamic assignment and network address translation. In consequence by using RTCP the network management system has information that is relevant to an individual user, but it is unknown to the network management system in which part of the network the UE operates. The “part of the network” (or segment of the network) is important to fault diagnosis management of a given service to users.

In addition RTCP summarization method, although leading to less RTCP receiver report traffic, loses information about sources of the reporting (i.e. IP addresses of the report sender). Therefore, after RTCP summarization, content senders or third-party monitors can only obtain a bulk of statistical values, without any knowledge about where the values come from.

### SUMMARY

Accordingly, the invention seeks to preferably mitigate, alleviate or eliminate one or more of the disadvantages mentioned above singly or in any combination.

According to a first aspect of the present invention there is provided a method of monitoring performance of a telecommunications network transmitting in real time multimedia data from a content provider to a device operating in said network. The method comprises the steps of receiving said multimedia data, collecting information about the connection used to receive the multimedia data and producing a receiver report for reporting statistics on received multimedia data based on the collected information. The method further comprises appending said report with an identifier of a segment of the telecommunications network in which the device operates. The report is then transmitted to said telecommunications network.

According to a second aspect of the present invention there is provided a device for use in a telecommunications network. The device is adapted to receive in real time, via said telecommunications network, multimedia data from a content provider. The device comprises a receiver section which is adapted to receive said multimedia data, a processing section which is adapted to collect information about the connection used to receive the multimedia data and to produce a receiver report for reporting statistics on received multimedia data based on the collected information. The processing section is further adapted to append said report with an identifier of a segment of the telecommunications network in which the device operates. The device also comprises a transmitting section adapted to transmit said report to said telecommunications network.

According to a third aspect of the present invention there is provided a telecommunications network comprising a plurality of devices operating in said network and at least one distribution source. The telecommunications network is adapted to transmit in real time multimedia data received from a content provider to at least part of the plurality of the devices. An individual device is adapted to receive said multimedia data, collect information about the connection used to receive the multimedia data and to produce a receiver report for reporting statistics on received multimedia data based on the collected information. The device is also adapted to append said report with an identifier of a segment of the telecommunications network in which the device operates and to transmit said report to said telecommunications network. Said network is further adapted to process said report to identify segments of the network where performance is degraded.

According to a fourth aspect of the present invention there is provided a distribution source adapted to transmit in real time via a telecommunications network multimedia data received from a content provider to a device operating in said network. The distribution source comprises an interface adapted to receive from said device a receiver report on statistics on received multimedia data and including an identifier of a segment of the telecommunications network in which the device operates. The distribution source is also adapted to forward the receiver report to a processing unit for processing said report in order to identify segments of the network where performance of said network is degraded.

Further features of the present invention are as claimed in the dependent claims.

The advantages of the present invention include, but are not limited to, simplified and accelerated network diagnosis that further facilitates root cause analysis in which monitoring tools can use the segment ID to identify the network segment of the receiver and produce network segment specific reports. The solution also allows for producing more accurate summarization reports. Reports from users that are experiencing temporary failures can be deleted from being sent to content senders. This would lead to fewer report blocks in summarization reports, and therefore reduce the packet size while rendering more accurate summarization of the end users experience.

The invention enables richer monitoring functionalities of performance for RTP streaming media (e.g., Mobile TV etc). Another benefit is that identifying the segment in which performance of the network is degraded allows for adjusting transmission parameters in order to mitigate the negative effects in the identified affected segment of the network.

### BRIEF DESCRIPTION OF THE DRAWINGS

The present invention will be understood and appreciated more fully from the following detailed description taken in conjunction with the drawings in which:

FIG. 1 is a diagram illustrating a method of monitoring performance of a telecommunications network in one embodiment of the present invention;

FIG. 2 is a diagram illustrating a device adapted to operate in the network in one embodiment of the present invention;

FIG. 3 is a diagram illustrating a telecommunications network in one embodiment of the present invention;

FIG. 4 is a diagram illustrating a distribution source in one embodiment of the present invention;

FIG. 5 is a diagram illustrating structure of a packet used in the method in one embodiment of the present invention.

### DETAILED DESCRIPTION

For the sake of clarity and simplicity, the embodiments described herein and illustrated in the figures present a mobile telecommunications network, but the invention is not limited to mobile telecommunications networks only. It can also be implemented in various wireline networks. Also for the sake of clarity the drawings in this application present the invention in a schematic way with elements and lines not essential for understanding the invention omitted.

The embodiments described herein below present the invention implemented in subscriber units (or user equipment), but this is only one possible embodiment. The present invention in alternative embodiments can also be easily implemented in other devices operating in the network, e.g. radio base stations (RBS), routers, etc.

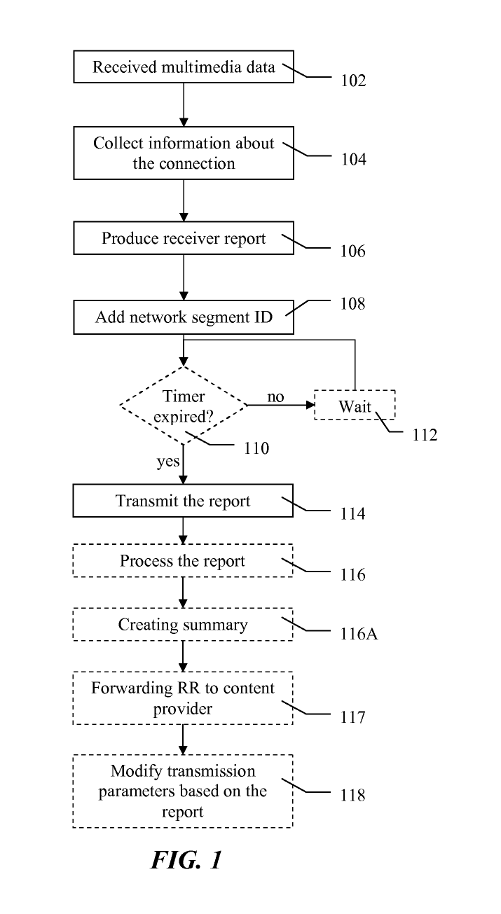

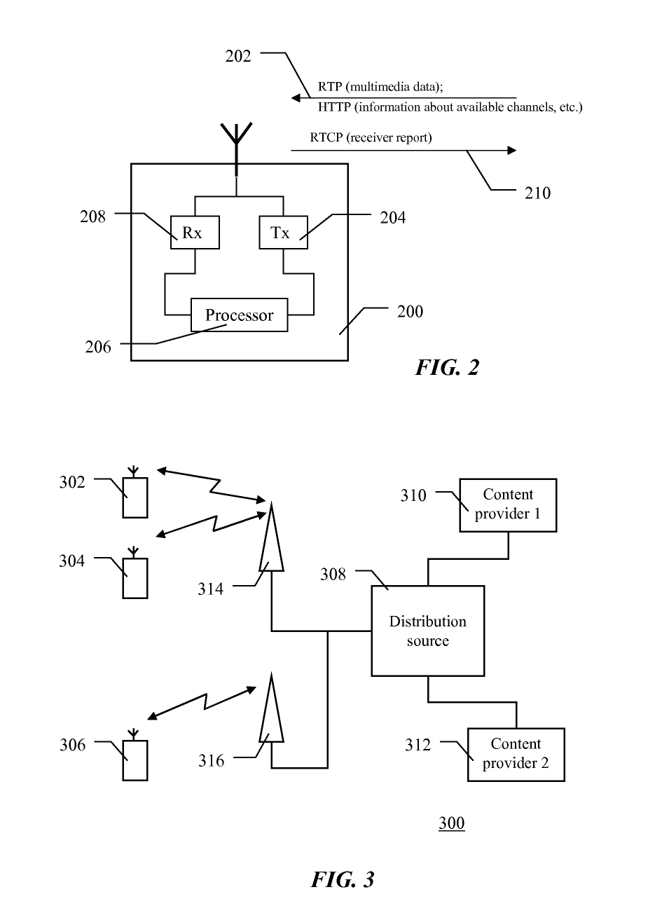

With reference to FIG. 1 and FIG. 3 one or more content providers 310, 312 (i.e. instances that send the media data) send RTP packets to a distribution source 308. The distribution source 308 relays the RTP packets via core and access network 314, 316 to subscriber units 302-306 using a source specific multicast arrangement. In the reverse direction, the subscriber units 302-306 transmit RTCP packets via unicast to the distribution source 308. The primary function of RTCP is to provide reception feedback on the quality of RTP media sessions, including packet loss, jitter and route trip delay.

In a preferred embodiment the access network is a 3G wireless telecommunications network, but the invention is not limited to 3G networks only. It is also applicable to other network technologies, e.g. media streaming in wireless LAN, Ethernet, Long Term Evolution (LTE) networks.

The present invention discloses a method of monitoring performance of a telecommunications network transmitting in real time multimedia data from a content provider to a subscriber unit. One embodiment of the method is illustrated in FIG. 1. In a solution operating according to this method the subscriber unit receives 102 said multimedia data and collects, 104, information about the connection used to receive the multimedia data. In various embodiments of the invention the collected statistics include any of the following (singly or in any combination):
loss statistics, including fraction lost, cumulative number of packets lost, and the highest sequence number received in an RTP data packet from source;
inter-arrival jitter, an estimate of the statistical variance of the RTP data packet inter-arrival time, measured in timestamp units and expressed as an unsigned integer;
the most recent RTCP sender report (SR) packet from source;
delay since last sender report.
   Using this information the subscriber unit produces 106 a receiver report on statistics on received multimedia data based on the collected information. The report is appended 108 with an identifier of a segment of the telecommunications network in which the subscriber unit operates. Once the report is completed, it is transmitted 114 to said telecommunications network.

FIG. 1 also illustrates alternative steps, marked with a dashed line. In a preferred embodiment the receiver report is processed 116 by the network taking into account the ID of the segment of the network in which the subscriber unit operates. It must be noted that the subscriber unit is capable of creating and transmitting the receiver report in accordance with embodiments of the present invention even if the network itself is not capable of processing the additional information about the segment of the network. In these situations the ID of the segment of the network is ignored by the network. This is an advantageous feature of the present solution which, can be easily introduced into the subscriber units and other devices operating in the network independently from introducing similar solution to the whole network. This means that when introducing this solution to the network it is not required to upgrade the whole network at the same time and, additionally, in the case of roaming between networks (or even parts of the same network), where one network is enabled to process the segment ID data and the other network is not capable of such processing the same subscriber unit can operate in both networks without modifications.

In the result of said processing it is identified in which segments of the network connection quality is degraded. This information allows for adjusting 118 transmission parameters precisely in these segments of the network where said degradation has been identified.

Also preferably, the subscriber unit transmits the receiver report periodically. In one embodiment a timer is started and it is checked 110 if said timer expired. If the answer is “yes” then the receiver report is transmitted to the network and then to the distribution source 308. If the answer is “no” the subscriber unit waits 112 with the transmission and collects data to be included in the report. When the timer expires the receiver report is transmitted.

Since the distribution source 308 knows which segments of the network suffer from low quality of the connection a preferred embodiment of this invention comprises modifying 118 transmission parameters in the segment (or segments) of the network identified as suffering degraded quality of transmission based on the receiver report.

The information provided in the receiver report allows in a preferred embodiment for adjusting 118 transmission parameters. The information contained in receiver report once processed by the distribution source is useful, for example, for control of adaptive encoding. The network, based on information from the distribution source, may modify its transmission parameters such as flow rate and codes.

The receiver report is extremely useful for fault diagnosis. It is critical to get feedback from the receivers to diagnose faults. Sending receiver reports to all participants allows one who is observing problems to evaluate whether those problems are local or global. With a distribution mechanism like IP multicast, it is also possible for network service providers to use profile-independent monitors to evaluate the performance of their networks and act as a third-party monitor to diagnose network problems. In particular, using the information in RTCP receiver report packets, it can be calculated:
Loss: The difference in cumulative number of packets between any two receiver reports gives the number lost during that interval. It is used to provide packet loss statistics (loss rate and loss ratio) and estimate the recent quality of multimedia sessions. A fraction lost field provides a short-term loss measurement from a single report.
Payload data rate: From the receiver report sender information, a third-party monitor can calculate the average payload data rate (number of packets received times the average payload size) and the average packet rate over a time interval without receiving the data.
Inter-arrival jitter: The inter-arrival jitter field indicates transient congestion before it leads to packet loss. It is intended for comparison across a number of reports from one receiver over time or from multiple receivers, e.g., within a single network, at the same time.

The receiver report is transmitted in a packet (or packets) and the ID of the network segment is inserted in the packet. Preferably, packet format compliant with the one of RTCP receiver reports as defined in RFC3550 is used. However, using other packet formats is also possible. This packet consists of a header, a number of report blocks and profile-specific extensions part. In a preferred embodiment of the present invention the profile-specific extensions part is used for appending the receiver report with the network segment ID and the other parts are kept unchanged (other than the length change considering the profile-specific extension size). As a result the modified RTCP packet is backward compatible with standard RTCP protocol and related tools. In the present invention the receiver (i.e. subscriber unit or other device operating in this network) inserts the network segment in which it operates into the profile-specific extensions part of the packet. Other software modules, for example, monitoring tools can read this part to find out the network segment and process it appropriately or, as explained earlier, can ignore it if they are not prepared to read and process the segment ID data. FIG. 5 illustrates one embodiment of a packet used for sending receiver report based on RTCP packet. The packet 500 comprises a header, report blocks 1 and 2 and the extension part containing the segment ID 502.

The fields of the RTCP extension in one embodiment of the present invention are as follows:
EXT_T: Type of RTCP Extension
V: Version of RTCP Extension;
EXT_LEN: Length of RTCP Extension;
SEG_ID: ID of the Network Segment that is being reported.

In one embodiment the distribution source 308 forwards 117 the received receiver reports to the content provider 310, 312. Preferably the content provider 310 receives receiver reports only from subscriber units 302, 306 that received multimedia data from said content provider 310. Forwarding 117 the receiver report to content provider is just one option; alternatively, the receiver report packets can be forwarded to any other node adapted to receive, process receiver report packets and take necessary actions. When the receiver reports (or summaries) are forwarded to the content provider said content provider may adjust the parameters of the provided multimedia stream on a global basis (i.e. the change will affect all devices receiving the multimedia data). A content provider may use this information to increase the quality of service, e.g. by limiting flow or using a different codec in certain scenarios. Other than the content provider, other designated nodes (e.g., RTP/TV QoE monitors or any other management node in the network) can process receiver report packets and take decisions accordingly. These decisions and processes (done by the content providers or other designated nodes) are not part of the present invention.

In order to fully utilize the additional information contained in the receiver report in a preferred embodiment the method comprises creating summaries 116A of received reports for different segments of the network. Summarisation modules in the distribution source use the segment ID to produce summaries 116A of reports for each segment. In alternative embodiments the summarisation modules are located in other part of the network and not in the distribution source. By producing summaries it is possible to identify performance issues related to a particular segment.

In one embodiment an average service quality statistics per network segment is calculated. If the total number of receiver reports is very large (e.g. larger than 100) and the number of reports with very high packet loss rate is very small (e.g. smaller than 3) the receiver reports with very high packet loss rate (compared with the average packet loss rate calculated above) are discarded. In order to have information about changes of quality of connections used for delivering multimedia data to subscriber units the distribution source keeps records of the QoS (quality of service) statistical information of each segment identified by segment ID (seg_id). In a preferred embodiment the distribution source puts its own identification as seg_id of the summarization message.

The steps of calculating an average service quality per network segment and discarding reports with very high packet loss rate work as a filter, which discards inaccurate or biased receiver reports and improves the accuracy. The two following steps (i.e. keeping records of QoS for different segments and inserting ID of the distribution source into the summarization messages) guarantee that there is no location information loss—monitors can inquire the distribution source to get the service quality statistics.

As mentioned earlier the present invention is applicable not only to subscriber units, but also to other devices operating in the network that receive the stream of multimedia data, e.g. RBS. In this alternative embodiment an RBS sends such receiver report back to distribution source. Having the reports also from the elements of network infrastructure makes it easier to identify where the problem is.

FIG. 2 illustrates one embodiment of a device 200 for use in a telecommunications network transmitting stream of multimedia data. In one embodiment the device 200 is a wireless subscriber unit, but the invention equally applies to wired devices and devices operating in the infrastructure of the network. The subscriber unit 200 is adapted to receive 202 in real time, via said telecommunications network, multimedia data from a content provider. In one embodiment the subscriber unit 200 receives the multimedia stream via a wireless link and in another embodiment via a wired connection. The device comprises a receiver section 204, which is adapted to receive said multimedia data, a transmitting section 208 and a processing section 206 adapted to collect information about the connection used to receive the multimedia data. The processing section in one embodiment is microprocessor running software designed to collect and process this information. In an alternative embodiment the processing section 206 is a digital signal processor or a set of microprocessors. The microprocessor 206 produces a receiver report containing statistics on received multimedia data. The receiver report is based on the collected information. The microprocessor 206 is further adapted to append said report with an identifier of a segment of the telecommunications network in which the subscriber unit 200 operates. The transmitting section 208 transmits 210 the receiver report to said telecommunications network.

In a preferred embodiment the microprocessor 206 inserts the identifier of a segment of the telecommunications network into extension part of the packet used for transmitting the receiver report.

Referring to FIG. 3 a telecommunications network 300 in one embodiment of the present invention is presented. The figure depicts a plurality of devices operating in said network (e.g. subscriber units 302-306, radio base stations 314, 316). The network also comprises at least one distribution source 308, which is the source of the multimedia data. The network 300 transmits in real time multimedia data received from a content provider 310 to at least part of the plurality of devices, 302-306, 314, 316, wherein an individual device receives said multimedia data and collects information about the connection used to receive the multimedia data. The individual device (subscriber unit or part of the network infrastructure) produces a receiver report for reporting statistics on received multimedia data based on the collected information. The device 302-306, 314, 316 appends said report with an identifier of a segment of the telecommunications network in which the device operates and transmits said report to said telecommunications network 300. Once the report is received by the network 300 infrastructure said network infrastructure processes it in order to identify segments of the network where performance is degraded.

In one embodiment said distribution source 308 processes said receiver report, however it is also possible that the processing is performed by external monitors, e.g. RTCP monitors.

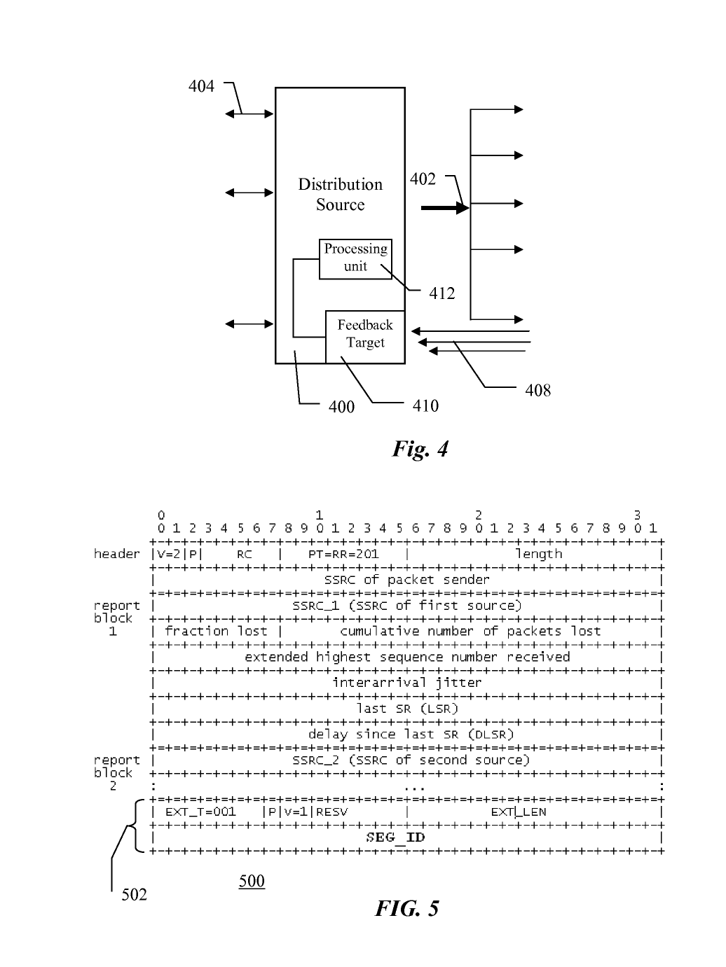

Referring to FIG. 4 a distribution source 400 is presented. The distribution source 400 transmits 402 in real time, via a telecommunications network, multimedia data received 404 from at least one content provider. The stream of multimedia data is transmitted to a device operating in said network (e.g. subscriber unit or part of the network infrastructure that the multimedia data stream passes through on its way to the subscriber unit). The distribution source comprises an interface 410 for receiving 408 from said device a receiver report on statistics on received multimedia data. The receiver report includes an identifier of a segment of the telecommunications network in which the device operates. The distribution source forwards the receiver report to a processing unit 412 adapted to process said report in order to identify segments of the network where performance of said network is degraded.

In a preferred embodiment the processing unit 412 (e.g. dedicated microprocessor, digital signal processor, a set of processors or software application operating on a microprocessor shared with other applications) is part of the distribution source 400, however in alternative embodiments it may be located outside the distribution source 400.

1. A method of monitoring performance of a telecommunications network transmitting in real time multimedia data from a content provider to a device operating in the network, the method comprising the steps of:
receiving said multimedia data;
collecting information about the connection used to receive the multimedia data;
producing a receiver report for reporting statistics on received multimedia data based on the collected information;
appending said report with an identifier of a segment of the telecommunications network the device operates in; and
transmitting said report to said telecommunications network.

2. The method according to claim 1 comprising processing said receiver report in order to identify segments of the network where performance of said network is degraded.

3. (canceled)

4. The method according to claim 1, wherein said telecommunications network multicasts the multimedia data to said device operating in the network and said device transmits in unicast the receiver reports to said telecommunications network.

5. (canceled)

6. The method according to claim 1 comprising forwarding the receiver report to the content provider.

7. The method according to claim 6, wherein the content provider receives receiver reports only from said device operating in the network that received multimedia data from said content provider.

8. The method according to claim 2 comprising modifying transmission parameters of the network in a segment of the network based on the receiver report.

9. The method according to claim 1, wherein said identifier of a segment of the telecommunications network is inserted into extension part of the packet used for transmitting the receiver report.

10. (canceled)

11. The method according to claim 1 comprising creating summaries of received receiver reports for different segments of the network.

12. (canceled)

12. A device for use in a telecommunications network adapted to receive in real time via said telecommunications network multimedia data from a content provider, wherein said device comprises a receiver section adapted to receive said multimedia data, a processing section adapted to collect information about the connection used to receive the multimedia data and to produce a receiver report for reporting statistics on received multimedia data based on the collected information; the processing section is further adapted to append said report with an identifier of a segment of the telecommunications network the device operates in and a transmitting section adapted to transmit said receiver report to said telecommunications network.

13. The device according to claim 12 adapted to periodically transmit the receiver report.

14. (canceled)

15. The device according to claim 12, wherein the receiver section is adapted to receive the multimedia data using Real-time Transport Protocol (RTP) protocol and the transmitter section is adapted to transmit the receiver report using Real-time Transport Control Protocol (RTCP) protocol.

16. A telecommunications network comprising a plurality of devices operating in said network and at least one distribution source, the telecommunications network being adapted to transmit in real time multimedia data received from a content provider to at least part of the plurality of devices, wherein an individual device is adapted to receive said multimedia data, collect information about the connection used to receive the multimedia data and produce a receiver report for reporting statistics on received multimedia data based on the collected information; the device is also adapted to append said receiver report with an identifier of a segment of the telecommunications network the device operates in and to transmit said receiver report to said telecommunications network and said network is further adapted to process said receiver report in order to identify segments of the network where performance is degraded.

17-18. (canceled)

19. The network according to claim 16, wherein said distribution source is adapted to receive multimedia data from more than one content provider.

20-21. (canceled)

22. The network according to claim 16, wherein the network is adapted to forward the receiver report to the content provider or a designated receiver report processing node.

23. (canceled)

24. The network according to claim 16 adapted to modify transmission parameters in a segment of the network based on the receiver report.

25. The network according to claim 16, wherein the device is adapted to insert said identifier of a segment of the telecommunications network into an extension part of the packet used for transmitting the receiver report.

26-27. (canceled)

28. A distribution source adapted to transmit in real time via a telecommunications network multimedia data received from a content provider to a device operating in said network; and comprising an interface adapted to receive from said device a receiver report on statistics on received multimedia data and including an identifier of a segment of the telecommunications network the device operates in and adapted to forward the receiver report to a processing unit adapted to process said receiver report in order to identify segments of the network where performance of said network is degraded.

29. The distribution source according to claim 28 further comprising said processing unit.

30. The distribution source according to claim 28, wherein said distribution source is adapted to receive multimedia data from more than one content provider.

31. (canceled)

32. The distribution source according to claim 28 adapted to forward the receiver report to the content provider or to other designated node.

33. The distribution source according to claim 32 adapted to forward to the content provider receiver reports only from devices that received multimedia data from said content provider.

34-35. (canceled)
